(19) United States
(12) Patent Application Publication
(10) Pub. No.: US 2009/0013807 A1
(43) Pub. Date: Jan. 15, 2009

(54) PIPE MONITORING METHOD

(75) Inventor: David Webster, Monmouth (GB)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Energy Equipment Corporation, Houston, TX (US)

(21) Appl. No.: 12/142,397

(22) Filed: Jun. 19, 2008

(30) Foreign Application Priority Data
Jun. 19, 2007 (GB) 0711843.3

(51) Int. Cl. F17D 3/00

(52) U.S. Cl. 73/866.5; 137/1; 208/370; 137/13; 137/561 R

(57) ABSTRACT

A method including locating at least one device in a conduit for exposure to ambient conditions within the conduit. The method comprises the steps of locating at least one device relative to a portion of a conduit and shaping the at least one device such that it is contiguous with the wall of the conduit.

### CROSS REFERENCE TO RELATED APPLICATION

This application claims priority to British Patent Application No. 0711843.3, filed Jun. 19, 2007, the entire contents of which are incorporated by reference herein.

### TECHNICAL FIELD

The present invention relates to a method of locating at least one device in a pipeline for exposure to the conditions of the pipeline.

### BACKGROUND

Instruments, devices and other apparatus are often required to be exposed to conditions within a pipeline. This allows pipeline conditions to be monitored for integrity purposes and to effect certain actions if the conditions within the pipeline are beyond acceptable limits. Typically, such instruments or devices are located in a branch of the pipeline having a blind end.

The environment in some pipelines can be hostile. One such example is a pipeline carrying hydrocarbons that are prone to waxing or hydrate formation. Typically, wax or hydrate formation can be problematic in areas where the rate of flow changes or there is a drop in temperature and/or pressure.

### SUMMARY

According to a first aspect of the invention there is provided a method of locating at least one device in a conduit for exposure to ambient conditions within the conduit comprising the steps of:

(a) locating at least one device relative to a portion of a conduit; and

(b) shaping the at least one device such that it is contiguous with the wall of the conduit.

Preferably, the result of the method of the invention is that a perfectly concentric throughbore is formed whereby the throughbore is defined at least in part by the device. The method of step (a) can include arranging the device in a known location relative to a portion of the conduit.

The method of step (b) can include machining at least a portion of the device such that it is contiguous with the wail of the conduit. In this way, the nose profile can be machined off a device so that it lies flush with the wall of the conduit.

Step (b) can include simultaneously shaping a throughbore of a conduit in a portion of material. Step (b) can include shaping the conduit wall and the device in one and the same operation to create a conduit having a conduit wall that is contiguous with the device. Step (b) can include machining the throughbore and the device.

The method can include joining the portion of the conduit to a pipeline by aligning the throughbores of the conduit and the pipeline and thereby creating a continuous fluid conduit. The method can include selecting the material of the portion of conduit to substantially match the material of the pipeline to which the conduit portion is to be joined.

The method can further include the step of exposing the at least one device to the ambient conditions of the conduit.

Since, the device is shaped to be contiguous with the wall of the conduit, the flow of the product within the conduit is unaffected by the presence of the device. Furthermore, when the product is flowing through the conduit portion, the boundary layer of the product created by the flow of the product along the conduit wall is unaffected by the presence of the device. This is because the device is contiguous with the conduit wall, which is thus free from anomalies. The lack of any interruption to the flow created by the device does not present conditions favouring formation of hydrates/waxes.

The method can include the further step of measuring one or more parameters in a conduit, comprising the steps of providing at least one measurement device and exposing the at least one device to the ambient conditions of the conduit and measuring one or more parameters of a conduit.

The product carried by the conduit can be a hydrocarbon mixture. The conduit can be a portion of pipeline.

The device can comprise any instrument for reporting one or more parameters of the conduit, such as temperature, pressure, flow rate and the like. Alternatively, the device can form part of a larger apparatus and can be provided to actuate apparatus coupled to the device in response to the conditions of the conduit reported by the device.

Defects, such as steps in the wall of the conduit can disrupt flow of a boundary layer along a conduit wall, causing eddies and wax or hydrate formation. The method of the invention eliminates these defects to reduce the likelihood of wax and hydrate specifically forming in the region of the device exposed to the ambient conditions of the conduit.

According to a first aspect of the invention, there is provided an apparatus for monitoring at least one parameter within a conduit, the apparatus comprising: a portion of conduit having a conduit wall; and a monitoring device that is shaped to be contiguous with the conduit wall.

Preferably, the contiguous pipeline wall forms a concentric throughbore.

Preferably the device is perfectly concentric with the conduit wall.

According to a second aspect of the invention, there is provided a method of monitoring conditions within a conduit comprising placing a monitoring device within a conduit, wherein the conduit has a wall and wherein at least a part of the monitoring device is contiguous with at least a part of the wall of the conduit.

According to the second aspect of the invention there is provided a conduit assembly comprising a conduit and a monitoring device, wherein the conduit has a wall and wherein at least apart of the monitoring device is contiguous with at least a part of the wall of the conduit. The part of the monitoring device that is contiguous with the wall of the conduit is exposed to the ambient conditions within the conduit.

Preferred features of the first aspect of the invention are also applicable to the second aspect of the invention where appropriate.

### BRIEF DESCRIPTION OF THE DRAWINGS

Embodiments of the present invention will now be described with reference to and as shown in the accompanying drawing in which:

FIG. 1 is a perspective view of a section through a pipeline formed according to the method of the invention.

### DETAILED DESCRIPTION

It will be appreciated that the following description is intended to refer to specific aspects of the representative structures selected for illustration in the drawings and is not intended to define or limit the technology of this disclosure other than in the appended claims.

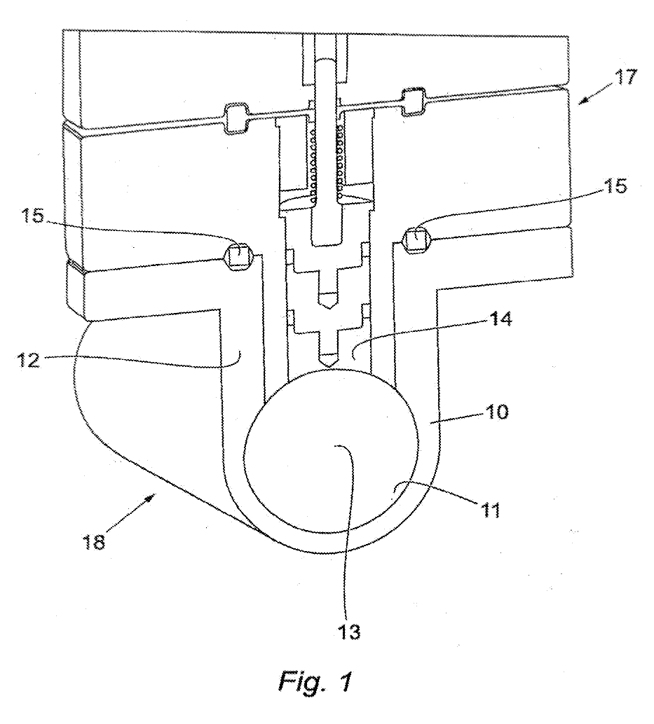

Referring to FIG. 1, a device shown generally at 17 has a housing 12 that slidably accommodates a piston 14. The device 17 is assembled within a block 10 of material that is eventually intended to form a part of pipeline. The device 17 is sealed within the block 10 by metal seals 15 that will fluidly isolate a throughbore of the pipeline once formed. The solid block 10 of metal that is intended to be machined into a pipeline is preferably selected from a material that matches the material of the pipeline to which it will eventually be joined.

The block 10 and the device 17 is then bolted to a saddle (not shown) to accurately centre and orient the block 10 and the device 17 relative to a machining tool (not shown) in preparation for the machining operation. The machining tool is rotated on an arm in an axial direction to machine out a throughbore 13 through the block 10 and the device 17 and produce a smooth pipeline wall 11 that is substantially concentric and free from anomalies. The block 10 is thus held stationary while the machining tool bores the concentric throughbore 13 through the block 10 and simultaneously machines away part of the device 17 itself. The result is a portion of pipeline shown generally at 18 in FIG. 1. There are no internal defects or steps in the wall 11 of the pipeline portion 18, which has a smooth throughbore 13 to restrict waxing and hydrate formation.

The throughbore 13 of the portion of pipeline 18 is then aligned with a throughbore of a pipeline (not shown) to which it is to be joined. Flanges (not shown) are provided at the ends of the machined pipeline portion 18 to effect the join. The flanges are provided with a metal ring at the interface with the adjoining pipeline to provide a fluid tight seal. The flange connections are made up so that the throughbore 13 is continuous with that of the pipeline.

The device 17 is part of a high-integrity pipeline protection system (HIPPS) (not shown). Generally, the HIPPS is arranged to isolate part of the pipeline downstream from an extraction facility to prevent pressure within the downstream part of the pipeline rising above a predetermined limit. This allows low-pressure rated thinner walled pipeline to be used for transportation of product in a pipeline since the HIPPS protects the pipeline from exposure to pressures higher than those for which the pipeline is rated. In order to actuate the HIPPS the piston 14 of the device 17 must be exposed to the conditions of the pipeline to monitor the pressure. When there is an overpressure in the pipeline, the piston 14 is radially movable to actuate the HIPPS in response to a pressure exceeding the accepted limits within the pipeline. The present invention can be used in conjunction with the HIPPS described in the published UK Patent Application number 2431485, which is hereby incorporated by reference.

The machining of the device 17 simultaneously with the machining of the throughbore produces a perfectly concentric wall 11 and eliminates any anomalies or steps. Such a step or other defect could encourage the formation of hydrates or waxes in the localised region. This can then affect the ability of the piston 14 of the device 17 to accurately reflect the pipeline pressure and could impair the proper and accurate function of the HIPPS, with potentially serious consequences.

According to an alternative embodiment, the device 17 is assembled around a pipeline already having a throughbore. The device 17 has a nose (not shown) that protrudes into the throughbore. The nose of the device 17 is then machined out of the throughbore to achieve a contiguous wall 11 and a smooth throughbore 13 again as shown in FIG. 1.

According to another embodiment of the invention, the device 17 is assembled in relation to the pipeline and the nose of the device 17 is machined out to create a continuous pipeline wall and a smooth throughbore with the pipeline in situ.

In each embodiment, the nose profile of an instrument or device protruding into a pipeline is completely eliminated and the instrument/device is contiguous and completely flush with the pipeline wall.

Rather then the piston 14 of the HIPPS device 17, the device exposed to pipeline conditions can be an instrument that measures one or more parameters of the pipeline. Where the invention relates to an instrument exposed to a pipeline carrying hydrocarbons, the benefits of having an instrument flush with the wall of the pipeline are twofold. First, the removal of defects in the pipeline wall prevents waxing and hydrate formation, which can cause production problems and reduce the effective bore size of the pipeline. Secondly, the parameters reported by the instrument are more accurate as the elimination of a nose profile means that the act of taking the measurement itself is less likely to interfere with the conditions of the pipeline, for example by disrupting flow rates, causing wax/hydrate formation.

Modifications and improvements can be made without departing from the scope of the invention.

Although the technology of this disclosure has been described in connection with specific representative forms thereof, it will be appreciated that a wide variety of equivalents may be substituted for the specified elements described herein without departing from the spirit and scope of this technology as described in the appended claims.

What is claimed is:

1. A method of locating at least one device in a conduit for exposure to ambient conditions within the conduit comprising the steps of:
(a) locating at least one device relative to a portion of a conduit; and
(b) shaping the at least one device such that it is contiguous with the wall of the conduit.

2. A method according to claim 1, wherein a perfectly concentric throughbore is formed whereby the throughbore is defined at least in part by the device.

3. A method according to claim 1, wherein the method of step (a) includes arranging the device in a known location relative to a portion of the conduit.

4. A method according to claim 1, wherein the method of step (b) includes machining at least a portion of the device such that it is contiguous with the wall of the conduit.

5. A method according to claim 4, wherein step (b) includes simultaneously shaping a throughbore of a conduit in a portion of material.

6. A method according to claim 5, wherein step (b) includes shaping the conduit wall and the device in one and the same operation to create a conduit having a conduit wall that is contiguous with the device.

7. A method according to claim 6, wherein step (b) includes machining the throughbore and the device.

8. A method according to claim 1 wherein the method includes joining the portion of the conduit to a pipeline by aligning the throughbores of the conduit and the pipeline and thereby creating a continuous fluid conduit.

9. A method according to claim 8 wherein the method includes selecting the material of the portion of conduit to substantially match the material of the pipeline to which the conduit portion is to be joined.

10. A method according to claim 1 wherein the method further includes the step of exposing the at least one device to the ambient conditions of the conduit.

11. A method according to claim 1, wherein the method includes the further step of measuring one or more parameters in a conduit.

12. A method according to claim 11 and further comprising the steps of providing at least one measurement device and exposing the at least one device to the ambient conditions of the conduit and measuring one or more parameters of a conduit.

13. An apparatus for monitoring at least one parameter within a conduit, the apparatus comprising: a portion of conduit having a conduit wall; and a monitoring device that is shaped to be contiguous with the conduit wall.

14. An apparatus according to claim 13, wherein the contiguous conduit wall forms a concentric throughbore.

15. An apparatus according to claim 13, wherein the device is perfectly concentric with the conduit wall.

16. A method of monitoring conditions within a conduit comprising locating a monitoring device within a conduit in accordance with the method of claim 1.

17. A method of monitoring conditions within a conduit comprising placing a monitoring device within a conduit in accordance with the method of claim 1.

18. A conduit assembly comprising a conduit and a monitoring device, wherein the conduit has a wall and wherein at least a part of the monitoring device is contiguous with at least a part of the wall of the conduit.

19. A conduit assembly according to claim 18, wherein the part of the monitoring device that is contiguous with the wall of the conduit is exposed to the ambient conditions within the conduit.
